(19) United States
(12) Patent Application Publication
(10) Pub. No.: US 2008/0046499 A1
(43) Pub. Date: Feb. 21, 2008

(54) System and Method for Attaching Advertisements to Media Files

(76) Inventors: Harold Cruz Cabrera, Winnipeg (CA); Richard Bruce Sloane, Winnipeg (CA); Stephen Andrew Wach, Winnipeg (CA); Kyle Andrew McGrath Geske, Winnipeg (CA)

Correspondence Address: Ade & Company;P.O. BOX 28006, 1795 HENDERSON HIGHWAY, Winnipeg, MB, R2G-4E9, US

(21) Appl. No.: 10/552,451

(22) PCT Filed: Apr. 5, 2004
(86) PCT No.: PCT/CA04/00487

§ 371 Date: Nov. 10, 2006

(30) Foreign Application Priority Data
Apr. 7, 2003 (CA) 2,424771

(51) Int. Cl. G06F 15/16

(52) U.S. Cl. 709/201

(57) ABSTRACT

The present invention relates to a polymer composition with good chemical properties and barrier properties being multimodal and comprising a polymer (A) having a weight average molecular weight of lower than 6000 g/mol and a polyolefine (B) having a higher weight average molecular weight than polymer (A) and a filler (C), whereby a polymer composition without filter (C) has a density of 940 kg/m³ or lower.

This invention relates to a system and method for appending secondary files to a primary file, of similar type, to be shared in a peer-to-peer (P2P) file-sharing network.

### BACKGROUND

A user of a P2P network can search for files on and download files from the hard drive of any other user of the same network. This file sharing technology allows the sharing of files of any file type. The files most frequently shared are music files. This resulted in the recent popularity of P2P file sharing networks. There now are several companies offering P2P software. While these companies boast millions of users on their networks, an effective business model that fully utilizes this user base has been lacking. Most companies resort to “Banner Advertising” or include “Spy Ware” with their software to generate revenue.

Furthermore, these P2P software providers face copyright based litigation from the recording industry. It is claimed that P2P file sharing networks are reducing record sales and that the artists are being compensated inadequately. The recording industry's strategy for dealing with P2P file sharing networks has been characterized as inefficient, impractical and expensive. It is, in any event, largely ineffective.

The present invention is intended to address and mitigate these concerns with the existing systems.

### SUMMARY

According to one aspect of the present invention there is provided a file sharing system having, a peer-to-peer file sharing network of the type including:

at least one first file storage for storing primary files to be shared; and

at least one primary client module connected to the first file storage for downloading files from the first file storage and from other clients over the network, and for uploading files to the first file storage and to other clients over the network, the improvement comprising:

a secondary file storage for storing secondary files;

a secondary client module connected to the primary client module for downloading secondary files from the secondary file storage, for forming composite file by appending a secondary file to each primary file downloaded by the primary client module and for causing the primary client module to upload only the composite files.

The secondary client module and the client module of the peer-to-peer file sharing network are preferably integrated. This permits the secondary file to be dynamically appended to the primary file. The composite file may contain an encrypted data segment to prevent unauthorized decoupling of the secondary file and the primary file. However, the encrypted data segment will preferably allow authorized decoupling of the secondary file and the primary file so as to append a new secondary file. Statistical information about the transmission of secondary files is passed from the secondary client module to the secondary file storage system for reporting.

The secondary file will be, in most cases an advertising file, the distribution of which will provide revenue to support the network and to compensate file owners, for example music publishers.

The peer-to-peer file sharing network may be any generally conventional network of this type, providing at least one file storage location for primary files. It also provides at least one client module connected to each file storage location and the network. These client modules allow for the downloading and uploading of primary files to and from the file storage location and network.

In most cases, the primary file, secondary file and composite file will all be media files with ID tags appended thereto identifying the content of the files. The secondary client module may include a means for interrogating the ID tag of a primary file for selecting a secondary file compatible with the ID tag.

The secondary client module may be integrated with the client module of the peer-to-peer file sharing network through an application programming interface. It downloads the secondary file from the secondary file storage system and appends the secondary file to the primary file. Also, the secondary client module causes the client module of the peer-to-peer file sharing network to upload only the composite file to the network or the first storage.

The preferred secondary file storage provides a management console to monitor and control all uploaded secondary files. In addition, it stores, displays, and reports statistical information about secondary files transferred to the secondary client module and appended to the primary files and about the distribution of composite files.

According to another aspect of the present invention there is provided a method of operating a peer-to-peer file sharing network including:

at least one first file storage for storing primary files to be shared;

at least one client connected to the first file storage for downloading files from the first file storage and from other clients over the network, and for uploading files to the first file storage and to other clients in the network, said method comprising:

providing a secondary file storage

storing secondary files in the secondary file storage;

downloading a primary file;

downloading a secondary file;

forming a composite file by appending a secondary file to the primary file; and

uploading the composite file to the network.

The method may include the steps of identifying an ID tag appended to the primary file; matching the ID tag with at least one compatible secondary file; downloading the compatible secondary file to the client module to be appended to the primary file with an encrypted data segment to form the composite file.

This system and method can deliver advertising messages, preferably targeted, promoting a particular product, service, individual, company, organization, event or any other data type that may be selected. The key distinguishing feature of this invention is the integration of a P2P client and the secondary client module that is responsible for appending the secondary files. This is different from most advertising delivery systems where a central server on the Internet appends the advertisement files. By having the P2P client perform the attachment, the system guarantees that all media files being shared on a P2P network will have an advertisement file appended to it.

### BRIEF DESCRIPTION OF THE DRAWINGS

In the accompanying drawings, which illustrate an exemplary embodiment of the present invention:

FIG. 1 illustrates the normal operation of a peer-to-peer file-sharing network;

FIG. 2 illustrates the operation of a P2P network integrated with a secondary client module and secondary file storage;

FIG. 3 is a flowchart depicting the secondary file selection process.

FIG. 4 depicts the process for transferring a secondary file to the secondary client; and

FIG. 5 depicts the structure of the composite file after a secondary file has been appended to a primary file.

### DETAILED DESCRIPTION

Referring to the accompanying drawings, there is illustrated a method and system for appending at least one secondary file to a primary file of similar type. For security purposes, the secondary and primary files are combined utilizing an encrypted data segment included with the secondary file. The resulting composite media file cannot be separated without decoding the encrypted data segment.

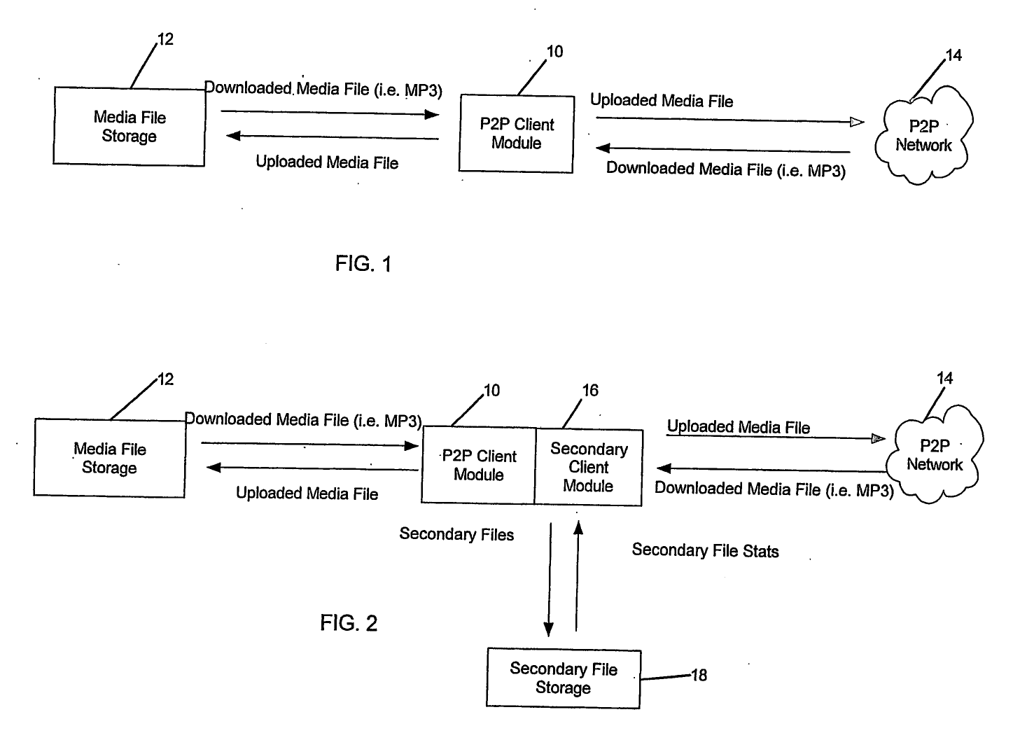

FIG. 1 illustrates a typical P2P environment in which the present invention operates, consisting of a client module 10 which allows a computer to share files from a file storage 12 with any other computer connected to the same network 14. The typical operation is as follows: a user will search for a file that he or she wishes to download and when a match returns, the user can select the desired file and start downloading it. When a file is being shared, the computer requesting the file will establish a direct connection to the other computer and then the download will start. The computer from where the files are being fetched is performing the uploading of the file to the requesting computer.

FIG. 2 shows the schematic diagram of the overall system including a secondary client module 16 integrated with the P2P client module 10. As in a typical P2P file sharing system, a user will download a file from a file storage location 12 or upload a file to a file storage location 12 via a P2P client module 10. However, in the present invention, a secondary client module 16 integrated with the P2P client module monitors file transfer activity, Once the P2P client receives a request, the secondary client module interrogates the primary file to determine what secondary files may be suitable for appending. This is particularly useful for incorporating targeted advertising messages to a specific audience. At least one secondary file is then appended to the primary file forming a composite file. Finally, the secondary client module enables the P2P client to upload the composite file either to the file storage or to the user of the P2P network.

The secondary file storage 18 is primarily responsible for sending the secondary files to the secondary client module. However, it also collects statistics about appended secondary files gathered by each of the secondary client modules. Both the secondary files and statistical information are stored in a database. The secondary file storage also has a graphical user interface (GUI) management console for creating and managing the different secondary files. In addition, the console enables viewing of statistics and generation of reports.

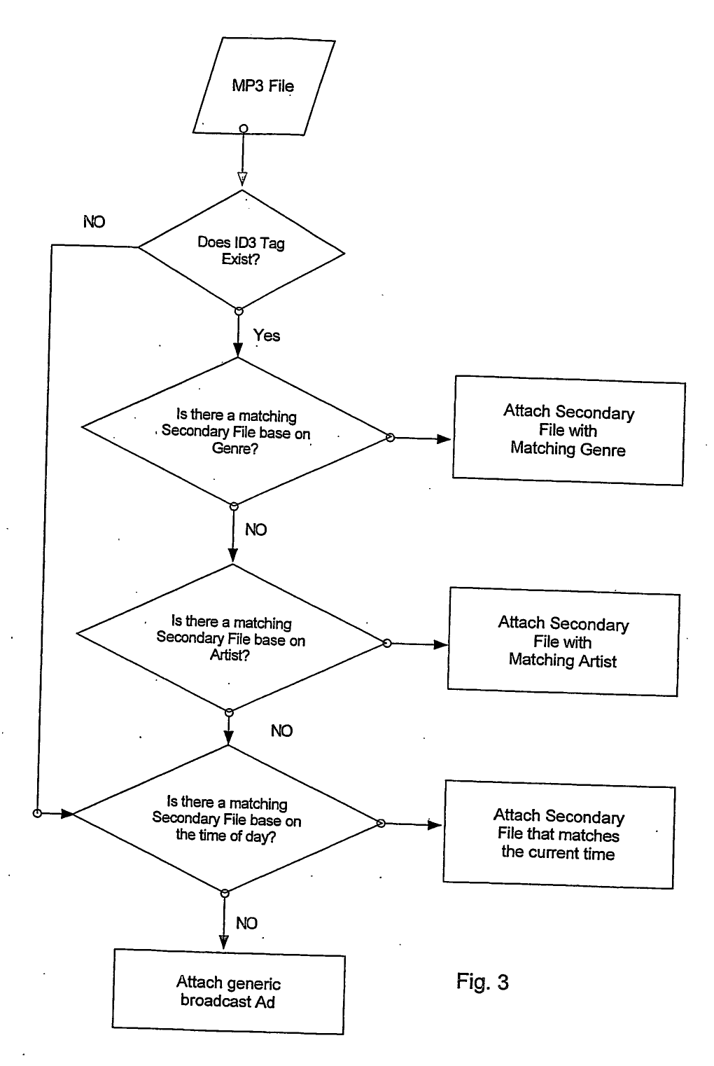

FIG. 3 illustrates the decision process for the selection of a secondary file for appending to a primary file. For example, when the P2P client module receives a file transfer request for an MP3 file, the secondary client module interrogates the file for an ID3 tag. If no ID3 tag exists, then a secondary file may be selected based on the time of day of its request. This is particularly useful when certain time intervals experience a large volume of file transfer requests, advertising could be sold for unique time slots. If there are no secondary files that match a time of day request, then a generic secondary file is selected for appending to the primary file.

If such an ID3 tag exists, it is examined for the media file's music genre and a secondary file is selected that matches a profile associated with the genre. However, in some cases no music genre information is present in the ID3 tag. In these cases, the ID3 tag is scrutinized for the artist of the media file and a secondary file is selected that matches a profile associated with the artist. When no information exists for both the genre and artist in the ID3 tag, a secondary file may be selected based on a time of day request, as above. Finally, when no secondary files matches a time of day request, then a generic secondary file is selected for appending to the primary file

In the example of a MP3 file, only the genre and artist was used for selecting appropriate secondary files for attachment. Clearly, other information could be used as selection criteria, for example the users sex, age, and location.

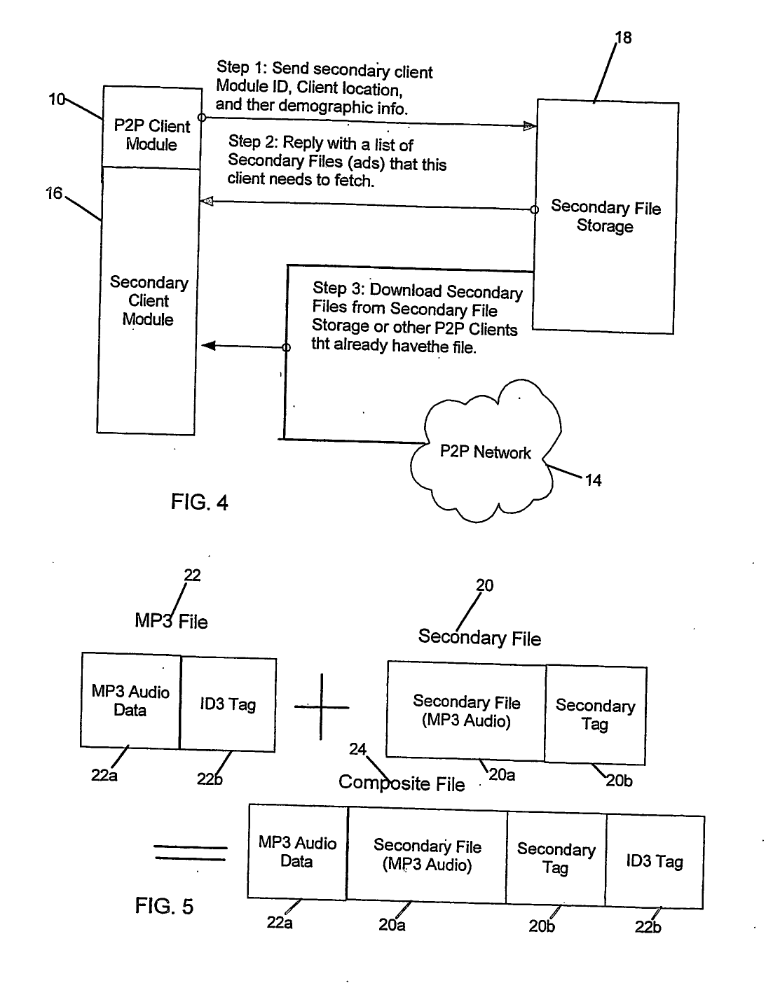

FIG. 4 shows the process of transferring a secondary file to the secondary client 16. The secondary client sends a request for secondary files to the secondary file storage 18, at a specified time interval. The request will contain information pertaining to the particular client, for example, client's ID, location and other demographic information. The secondary file storage replies by sending a list of secondary files required by the secondary client based on the information provided in the request. The secondary client will download-the required secondary files from the secondary file storage or other P2P clients on the same P2P network 14. This whole process is repeated at each specified time interval.

FIG. 5 shows how a secondary file 20 is attached to a primary file 22 and the structure of the resulting composite file 24. The secondary file data component 20a is dynamically attached to the end of the primary file data component 22a with the resulting composite file appearing to be a single file. Alternatively, the secondary file data component 20a could be added to the beginning of the primary file data component. The secondary file is appended to the primary file and there is no way it can be removed without decoding an encrypted data segment included in a secondary tag 20b that is part of the secondary file. The secondary tag 20b contains information about the secondary file and the type of primary file it should be appended to. In FIG. 3, the example used is that of an MP3 file. The ID3 tag 22b on the MP3 file contains Information about its music genre. This information is matched to the secondary tag of the secondary file, for example, an advertisement file.

While one embodiment of the present invention has been described in the foregoing, it is to be understood that other embodiments are possible Within the scope of the invention. The invention is to be considered limited solely by the scope of the appended claims.

1. A file sharing system having, a peer-to-peer file sharing network of the type including:
at least one first file storage for storing primary files to be shared; and
at least one primary client module connected to the first file storage for downloading files from the first file storage and from other clients over the network, and for uploading files to the first file storage and to other clients in the network, the improvement comprising:
a secondary file storage for storing secondary files;
a secondary client module connected to the primary client module for downloading secondary files from the secondary file storage, for forming a composite file by appending a secondary file to each primary file downloaded by the primary client module and for causing the primary client module to upload only the composite file.

2. A system according to claim 1 wherein the primary file, secondary file and composite file are all media files with an ID tag appended thereto identifying the content of the files.

3. A system according to claim 2 wherein the secondary client module includes a means for interrogating the ID tag of a primary file for selecting a secondary file compatible with the ID tag.

4. A system according to claim 1 wherein the secondary client module is integrated with the client module of the peer-to-peer file sharing network through an application programming interface.

5. A system according to claim 1 wherein the secondary file storage includes a management console to monitor and control all uploaded secondary files.

6. A system according to claim 1 wherein the secondary file storage stores, displays, and reports statistical information about secondary files uploaded to the secondary client module.

7. A method of operating a peer-to-peer file sharing network including:
at least one first file storage for storing primary files to be shared;
at least one client connected to the first file storage for downloading files from the first file storage and from other clients over the network, and for uploading files to the first file storage and to other clients in the network, said method comprising:
providing a secondary file storage
storing secondary files in the secondary file storage;
downloading a primary file;
downloading a secondary file;
forming a composite file by appending a secondary file to the primary file; and
uploading the composite file to the network.

8. A method according to claim 7 further comprising the steps of:
receiving a request for a primary file from a user through the client module;
identifying a primary file ID tag forming part of the primary file;
matching the primary file ID tag with a compatible secondary file;
downloading the compatible secondary file to the client module;
forming a composite file by appending the compatible secondary file to the primary file; and
uploading the composite file to said user.

9. A method according to claim 7 wherein the secondary file is dynamically appended to the primary file.

10. A method according to claim 7 further comprising including in the composite file an encrypted data segment to prevent unauthorized decoupling of the secondary file and the primary file.

11. A method according to claim 10 further comprising decoding the encrypted data segment, decoupling the secondary file from the primary file and appending a new secondary file to the primary file.

12. A method according to claim 1 including recording statistical information about the downloading and uploading of secondary files.
